(19) United States
(12) Patent Application Publication
(10) Pub. No.: US 2008/0200146 A1
(43) Pub. Date: Aug. 21, 2008

(54) CELL ACCESS RESTRICTION AND WTRU ACCESS CLASS OPTIMIZATION IN LTE SYSTEM INFORMATION

(75) Inventors: Peter S. Wang, East Setauket, NY (US); Ulises Olvera-Hernandez, Kirkland (CA); Jin Wang, Central Islip, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/022,528

(22) Filed: Jan. 30, 2008

Related U.S. Application Data
(60) Provisional application No. 60/887,286, filed on Jan. 30, 2007.

(51) Int. Cl. H04M 3/16; H04M 1/68; H04M 1/66

(52) U.S. Cl. 455/410

(57) ABSTRACT

A method and apparatus for cell access restriction, wherein a new access class (AC) definition including a WTRU barred-bit assignment is assigned during cell subscription. A cell access restriction information element (IE) is then broadcast when an operator is restricting access to a cell. The WTRU then can determine whether a cell is restricted based on a comparison of the cell access restriction IE to the barred-bit definition. A base station (BS) is able to transmit the new cell access restriction IE in a fast-read master information block (MIB).

### CROSS REFERENCE TO RELATED APPLICATION

This application claims the benefit of U.S. provisional application No. 60/887,286 filed on Jan. 30, 2007, which is incorporated by reference as if fully set forth.

### FIELD OF INVENTION

This invention related to wireless communication systems.

### BACKGROUND

The Third Generation Partnership Project (3GPP) initiated the Long Term Evolution (LTE) program to provide improved spectral efficiency and faster user experiences. One improvement implemented in LTE is the use of cell access restrictions. During periods where usage demands exceed cell bandwidth, (e.g., emergency situations, when the system is restarted, or during maintenance), users may overflow the system with access requests. Cell access restriction reduces cell overload in high usage situations by limiting the number wireless transmit/receive units (WTRUs) that may access a cell at a given time.

In cell selection procedure a WTRU selects a cell in which it can reliably decode downlink data and with a reliable uplink communication. Access to the network is typically conditional on the successful selection of a cell. Therefore, it is important for a WTRU to determine whether a cell is blocked or available. During this process, a cell may receive a cell access restriction information element (IE) indicating the current operating state of the cell. Similarly procedures exist during cell reselection, where a WTRU is switched from one cell to another. Cell access restriction may be used to control cell selection and reselection procedures during the high cell usage situations.

Two mechanisms may be used by an operator to impose cell access restrictions. The first mechanism is an indication of cell status and special reservations for control of cell selection and reselection. The second mechanism, referred to as access class control, prevents selected classes of users from sending initial access messages for control of emergency calls.

When an access class control mechanism is used, a base station (BS) assigns access classes (ACs) to each WTRU during the subscription process. The AC is a number assigned to a WTRU with values ranging from 0 to 15. A WTRU may receive multiple ACs depending on the particular cell access restriction scheme involved. The AC numbers are then stored on the WTRU. During restricted access periods, the system may select a subset of the ACs that are allowed to use the cell, and the system broadcasts permission marks only for the selected ACs. The BS broadcasts a cell access restriction IE to all of the WTRUs indicating which ACs may access and what level of access is available. Therefore a WTRU can know whether the cell is available or barred for cell selection/reselection. An advantage of this feature is that the system overhead does not depend on the number of WTRUs. The 3GPP specification assumes that access control is not used under normal operating conditions, but rather under certain specific conditions where the operator wants to protect its radio access channels from becoming overloaded.

The organization of the cell access restriction and WTRU AC information elements (IEs) as defined for a Universal Mobile Telecommunications System (UMTS) IE is shown in Table 1 below.

TABLE 1
UMTS cell access restriction definition

| IE/Group name | Need | Type and reference |
|---|---|---|
| Cell Barred | MP | Enumerated (not barred, barred) |
| Intra-frequency | CV-Barred | Enumerated (not allowed, allowed) |
| cell reselection | | |
| indicator | | |
| T_{barred} | CV-Barred | Integer (10, 20, 40, 80, 160, 320, |
| | | 640, 1280) |
| Cell Reserved for | MP | Enumerated (reserved, not |
| operator use | | reserved) |
| Cell Reservation | MP | Enumerated (reserved, not |
| Extension | | reserved) |
| AC Barred List | CV-SIB3-MD | |
| AC Barred | MP | Enumerated (not barred, barred) |

Referring to Table 1, the current definition for the WTRU AC IEs includes three mandatory presence (MP) IEs used for cell access restriction in UMTS. The three MPs include: 1) cell-barred; 2) cell-reserved-for-operators; and 3) cell-reserved-for-future-extensions. The three MPs are used to delineate only four possible scenarios specified in the 3GPP standard. Therefore, a method for cell access restriction with reduced control variables is needed.

### SUMMARY

A method and apparatus for cell access restriction, wherein a new cell access definition including a WTRU barred-bit assignment is assigned during cell subscription and a new access class definition. A cell access restriction information element (IE) is then broadcast when an operator is restricting access to a cell. The WTRU then can determine whether a cell is restricted based on a comparison of the cell access restriction IE to the barred-bit definition. A base station (BS) is able to transmit the new cell access restriction IE in a fast-read master information block (MIB) or a system information block (SIB) or a signaling unit (SU).

### BRIEF DESCRIPTION OF THE DRAWINGS

A more detailed understanding may be had from the following description, given by way of example and to be understood in conjunction with the accompanying drawings wherein:

FIG. 1 is an example wireless communication system including a plurality of wireless transmit/receive units (WTRUs), and a base station;

FIG. 2 is a functional block diagram of a WTRU and the base station of FIG. 1; and

FIG. 3 is a flowchart of an example cell access restriction procedure and an access control class check procedure.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

A cell implementing cell access restriction may be categorized by the four following scenarios. In the first scenario, a cell is operating, which means cell selection and reselection is allowed for all types of WTRUs, whether they are in idle mode or connected mode. In a second scenario, cell selection and reselection is barred, for a time interval T_{barred}, for all WTRUs, even for emergency calls. In this second scenario, a WTRU reselection may not occur to another intra-frequency cell with the same frequency band as the barred cell. However, after a time period T_{barred} a WTRU is permitted to restart the cell selection/reselection process. In a third scenario, a cell is barred for cell selection and reselection for public land mobile network (PLMN) maintenance such that only WTRUs in an AC assigned to PLMN Staff or PLMN Service can access the cell. Finally in a fourth scenario, a cell is barred to all WTRUs, but, reselection to another cell on the same frequency band is possible.

A reduction of cell access restriction signaling space is described herein. With a reduction of cell access restriction signaling space the LTE system information broadcast may include an optimized cell access restriction IE and possibly a WTRU AC for emergency call information in the top LTE fast-read-master information block (MIB), an SIB, or an SU for cell search/cell selection. This enables WTRUs for cell selection and cell reselection to know whether the target cell is suitable to carry out the intended service by only one or the least possible number of neighboring cell system information block (SIB) or Signaling Unit (SU) reading.

Currently the PLMN-ID/Cell-ID/TA-ID and other vital cell search/cell selection IEs are transmitted in a first SIB (compared to MIB in current UMTS) and the cell access restriction/WTRU AC barred to emergency calls IEs are transmitted in a second SIB (in the current UMTS standard it is in SIB-3/4). Furthermore, two SIB readings are needed to find out whether the cell is suitable or not. Therefore, a method and apparatus that allow inclusion of an optimized cell access restriction IE and the AC barred to emergency call status information, both described in detail below, is desired.

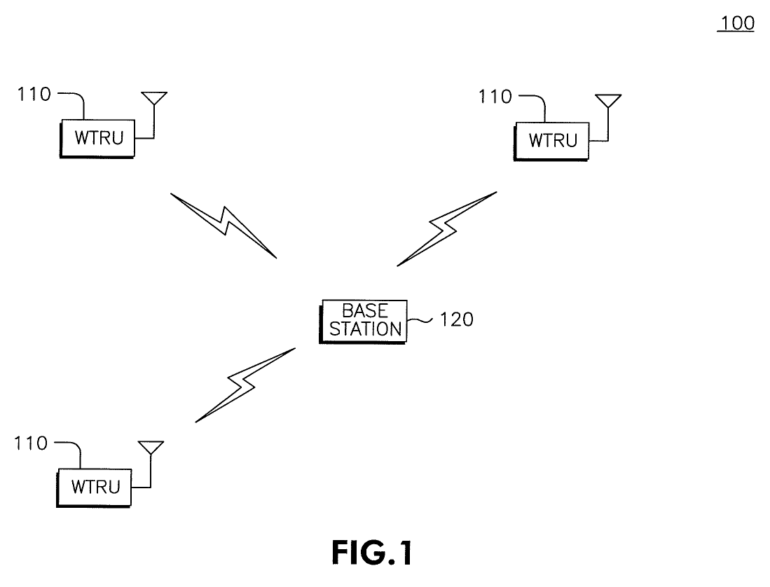

FIG. 1 shows a wireless communication system 100 including a plurality of WTRUs 110, and a BS 120. As shown in FIG. 1, the WTRUs 110 are in communication with the BS 120. Each WTRU 110 receives an AC from the BS 120 during the cell subscription process. During high occupancy and other periods, the BS 120 may enact cell access restriction, and limit access by the WTRUs. Although three WTRUs 110, and a BS 120 are shown in FIG. 1, it should be noted that any combination of wireless and wired devices may be included in the wireless communication system 100.

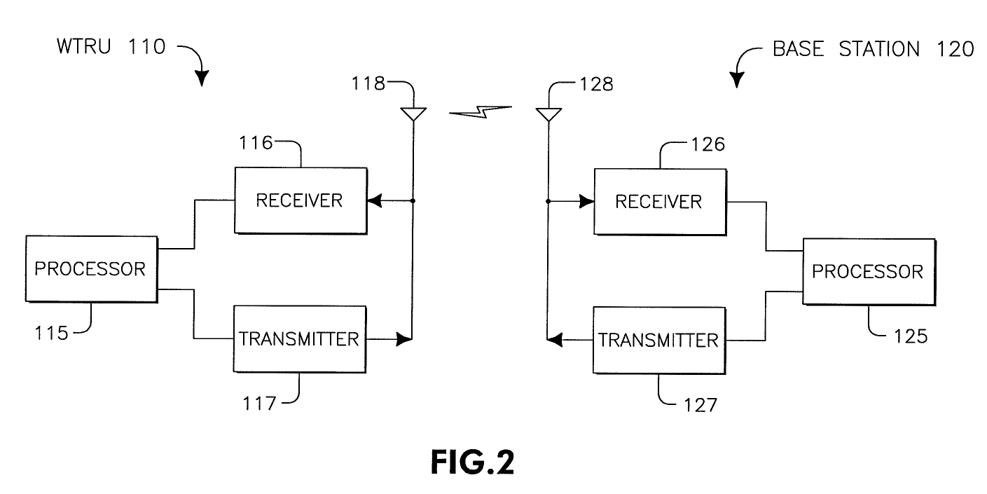

FIG. 2 is a functional block diagram 200 of a WTRU 110 and the BS 120 of the wireless communication system 100 of FIG. 1. As shown in FIG. 1, the WTRU 110 is in communication with the BS 120 and both are configured to perform cell access restriction and WTRU AC optimization procedures.

In addition to the components that may be found in a typical WTRU, the both the receiver 116 and the transmitter 117 to facilitate the transmission and reception of wireless data.

In addition to the components that may be found in a typical BS, the BS 120 includes a processor 125, a receiver 126, a transmitter 127, and an antenna 128. The processor 125 is configured to perform cell access restriction and WTRU AC optimization procedures. The receiver 126 and the transmitter 127 are in communication with the processor 125. The antenna 128 is in communication with both the receiver 126 and the transmitter 127 to facilitate the transmission and reception of wireless data.

Given that a cell implementing cell access restriction may be categorized by the four scenarios discussed above, three of the seven variables may not be necessary and at least one is not needed. Currently the three cell access restriction variables are the “cell barred”, the “cell reserved for operator use” and the “cell reservation extension.” It is not necessary to use three variables to distinguish the four scenarios, instead a two-bit variable may adequately distinguish the four scenarios and therefore some of the three variables could be eliminated. Accordingly, a solution where the cell access restriction IE has one cell restriction status variable is hereby introduced. The new IE includes the following status types: cell operating; cell Barred-to-All (alternatively no intra-frequency cell reselection); cell Barred-for-PLMN Maintenance (alternatively no intra-frequency cell reselection); and cell Barred-Reselection-Allowed (may select/reselect to another intra-frequency cell). In any of the aforementioned cell barred status types, the barred cell is not to be selected or reselected even for emergency calls. However, if the WTRU is already engaged in an emergency call, then it may select or reselect another intra-frequency cell. By reducing the size of the cell access restriction IE, the cell access IE can be signaled over the system information first-to-read MIB or a SIB/SU. By making this IE available earlier to a WTRU in a reselection or an access process, congestion may be reduced.

The AC Barred List, shown in Table 1, is a conditional-on-value (CV) variable, i.e. its presence in the IE is conditional based on the presence of other variable values. The AC Barred List is used to manage emergency calls from the cell. A WTRU receives the AC Barred List IE from the cell to determine which ACs are barred from making emergency calls. If the AC Barred List indicates that one or more AC is barred, the WTRU then checks its own AC assignment located in its own memory to determine if it is barred from emergency access. The functionality of the AC Barred List can be addressed in emergency call rules specification and with IE changes, as will be shown below.

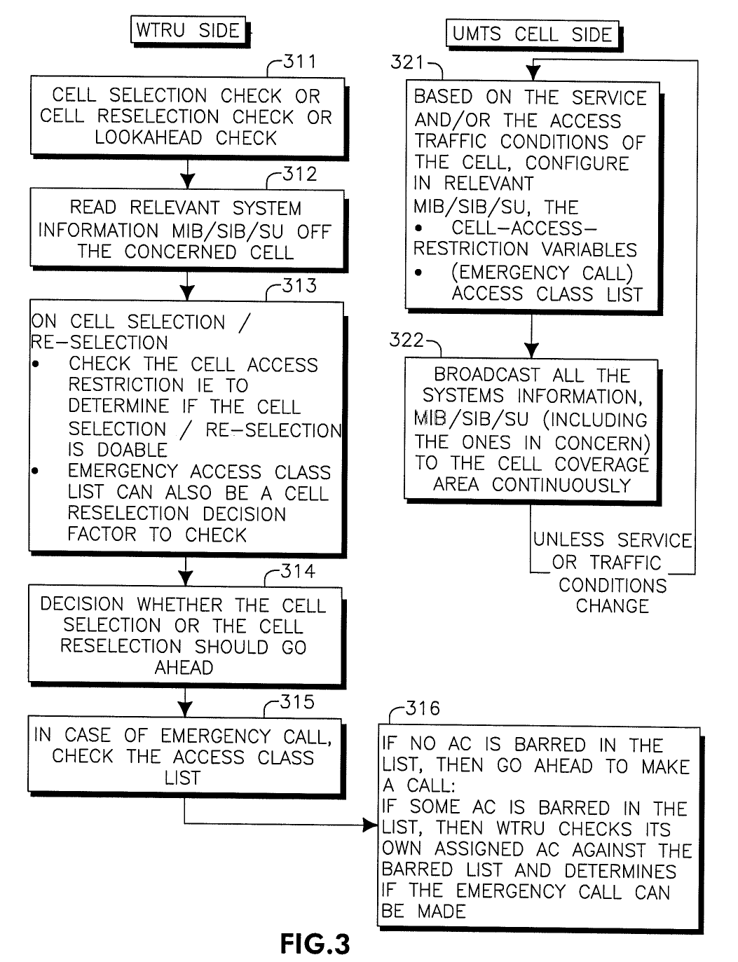

FIG. 3 is a flowchart of an example cell access restriction procedure and the AC list check procedure. It should be noted that typically the access control class is assigned to the WTRU by the service provider when the handset is purchased. The AC class is typically programmed into a universal subscriber identity module (USIM) card attached to the handset, or in the alternative, some of the USIM contents can be downloaded to the WTRU over the air at the WTRU activation time. Typically, a BS operating in a cell continuously transmits system information. Based on the service and/or traffic conditions of the cell, the BS configures the MIB, SIB, or SU to include the cell access restriction variables and the emergency call AC list (321). After configuring the MIB/SIB/SU, the BS broadcasts the system information in the MIB/SIB/SU to the cell coverage area continuously (321). The BS will broadcast the same information, unless traffic or service conditions change, in which case it reconfigures the MIB/SIB/SU.

Referring to FIG. 3, during an initial subscription process, a WTRU initiates a cell selection check, cell reselection check, or look-ahead check and receives the cell access restriction variables and emergency call AC list (311). The WTRU then reads the relevant system information MIB/SIB/SU of the target cell (312). The WTRU then checks cell access restriction IE to determine if the cell selection/reselection is possible, the WTRU may also check the emergency cell AC list (313). The WTRU decides whether a cell is a candidate for selection or reselection (314). Once the WTRU selects a cell, the WTRU may determine whether an emergency call is necessary (315). If no AC is barred, then the WTRU can make the emergency call, however if an AC is barred, then the WTRU checks its own assigned AC against the barred list and determines if the emergency call can be made (316).

Table 2 below shows an example cell access restriction IE. Referring to the Cell Barred Status IE, if the value of the IE indicates Barred-to-All then the cell is barred to all WTRUs. If the Cell Barred Status IE indicates Barred-for-PLMN-Maintenance then cell access is barred to all users except those located in the ACs assigned to PLMN staff or PLMN service (i.e. ACs 11-15). If the Cell Barred Status IE indicates Barred-Reselection-Possible, then all users are barred, but reselection to another cell in the same frequency is still possible. WTRU with emergency call already in progress can select to another cell. Alternatively the Cell Barred Status IE may indicate that reselection is possible after a predetermined time interval T_{barred}, in which case the reselection indicator and the T_{barred} are used to determine when/if reselection is possible.

TABLE 2
LTE cell access restriction IE

| IE/Group name | Need | Type and Reference |
|---|---|---|
| Cell Barred Status | MD | Enumerated (Barred-to-All, |
| | | Barred-for-PLMN-Maintenance, |
| | | Barred-Reselection-Possible, |
| | | Reserved) |
| Intra-frequency Cell | CV-Barred- | Enumerated (not allowed, allowed) |
| Reselection | Reselection- | |
| Indicator | Possible | |
| T_{barred} | CV-Barred- | Integer (10, 20, 40, 80, 160, |
| | reselection- | 320, 640, 1280) |
| | possible | |

Further, given that the Cell Barred Status IE already includes the parameter Barred-Reselection-Possible, a separate CV for the Intra-frequency Cell Reselection Indicator may not be necessary. Therefore, a more compact construction, shown in Table 3, is possible where T_{barred} is modified toward LTE interpretation semantics, as shown below.

In Table 3, if the Cell-Barred Status IE indicates Barred-to-All then cell access is barred to all WTRUs. If the Cell-Barred Status IE indicates Barred-for-PLMN-Maintenance then only AC's associated with PLMN staff or PLMN service (i.e. ACs 11-15) may access. If the Cell-Barred Status IE indicates Barred-Reselection-Possible then all users are barred; however reselection to another cell in the same frequency is possible, (i.e., the reselection indicator and the T_{barred} are used to determine when/if reselection is possible). T_{barred} is an integer value (in seconds). The MD is set for a maximum T_{barred} value, where reselection is possible after a time T_{barred}. If T_{barred} is present, it automatically indicates that cell access is barred for duration T_{barred}, and the WTRU may check for access after a time T_{barred}.

TABLE 3

| IE/Group name | Need | Type and Reference |
|---|---|---|
| Cell Barred Status | MD | Enumerated (Barred-to-All, |
| | | Barred-for-PLMN-Maintenance, |
| | | Barred-Reselection-Possible, |
| | | Reserved) |
| T_{barred} | MD | Integer (10, 20, 40, 80, 160, 320, 640, 1280) |

The current definition for WTRU ACs, (0-9, 11-15), and its representation in system information with respect to emergency call barring, is shown in Table 4 below:

TABLE 4
Current AC Definition and their signaling definitions

| AC # | | | | | | | | | | | | | | | |
|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 |

| Bit | Bits in 0-9 mean individual | Bit-10 | Emergency calls are barred if | | | | |
|---|---|---|---|---|---|---|---|
| semantics | class are barred from | bars all | Bit-10 and an individual bit | | | | |
| | emergency calls | lower | (any of bits 11-15) are barred | | | | |
| | | AC | | | | | |
| | | WTRUs | | | | | |
| AC | Ordinary user WTRU ACs, | No AC | PLMN use | Security | Public | Emergency | PLMN |
| Definition | include those HPLMN and | meaning | | Services | Utilities | | Staff |
| | those from visit-PLMN | | | | | | |

A priority feature may also be implemented in cell access restriction, where the AC's can be organized according to priority. In one embodiment, AC 11 associated with PLMN use, and AC number 15 indicating PLMN staff, have higher emergency call priorities over all other ACs, (i.e., 0-9, 12-14). A priority listing of the WTRU AC is shown in Table 5 below.

TABLE 5
AC LTE Reordering 1

| AC # | | | | | | | | | | | | | | |
|---|---|---|---|---|---|---|---|---|---|---|---|---|---|---|
| 0 | 1 | 2 | 3 | 4 | 5 | 6 | 7 | 8 | 9 | 12 | 13 | 14 | 11 | 15 |

| Priority | Ordinary | high | higher | higher+ | highest | |
|---|---|---|---|---|---|---|
| Order | | | | | | |
| AC | Ordinary user WTRU classes, | Security | Public | Emergency | PLMN use | PLMN Staff |
| Definition | include those HPLMN and those | Services | Utilities | Services | | |
| | from visit-PLMN | | | | | |

As seen in Table 5, the ACs for emergency service and security service (ACs 14 and 12 respectively) are given higher priority during an emergency as compared to the public service ACs. The WTRU AC list shown in Table 6 below is organized according to priority. The PLMN use and PLMN staff ACs are assigned the highest priority, followed by emergency services, security services, maintenance, and finally the ordinary users.

TABLE 6
AC priority reordered for LTE Emergency Call

| | AC # | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 13 | 12 | 14 | 11 | 15 |
| Priority | Ordinary | | | | | | | | | | high | higher | | highest | |
| Order | | | | | | | | | | | | | | | |
| AC | Ordinary user WTRU ACs, | | | | | | | | | | Public | Security | Emergency | PLMN use | PLMN Staff |
| Definition | include those HPLMN and those | | | | | | | | | | Utilities | Services | Services | | |
| | from visit-PLMN | | | | | | | | | | | | | | |
| Permission | 1 | 2 | 3 | 4 | 5 | 6 | 7 | 8 | 9 | 10 | 11 | 12 | 13 | 14 | 15 |
| Class | | | | | | | | | | | | | | | |
| Definition-1 | | | | | | | | | | | | | | | |

| | | | | | | | | |
|---|---|---|---|---|---|---|---|---|
| Permission | 1 | 2 | 3 | 4 | 5 | 6 | 7 | 8 |
| Class | | | | | | | | |
| Definition-2 | | | | | | | | |

| | | | | |
|---|---|---|---|---|
| Permission | 1 | 2 | 3 | 4 |
| Class | | | | |
| Definition-3 | | | | |

According to one embodiment, the new emergency call class is redefined for LTE with three new WTRU AC orderings (Permission Classes definitions 1 to 3) and representations as shown in Table 6 above.

In the Permission Class Definition-1, the original sixteen bit definition, represented by ACs 0-15, is reduced to a 15-bit definition, where the former tenth bit (AC 10) is deleted because it is redundant. Previously, a WTRU would need to read bit-10 to determine if any AC is barred, and then read its own barred-bit to know if the WTRU is barred. Using the AC ordering shown in Permission Class Definition-1, the maintenance classes, (ACs 11 to 15), are barred with only their own barred-bit, so there is no need for former Bit-10. Accordingly, WTRUs with a regular user class (AC 0-9) need only to read their own barred-bit to know if a cell is barred or not. For WTRUs in the PLMN ACs, (i.e., ACs 11-15), only the WTRU's own barred-bit needs to be read (also avoids reading Bit-10). In some cases the network may need to set all the barred-bits if several ordinary user ACs are barred, however the processing burden is on the network rather than the WTRU. This allows for WTRU efficient processing, and SIB space is saved.

In the Permission Class Definition-2, selected former ordinary user ACs, (i.e., ACs 0-9), are combined together into a new barring group of three (New ACs 1-3). The new barring group covers ordinary users from the home PLMN (HPLMN) and a visiting PLMN (VPLMN). In implementing Permission Class Definition-2 it is assumed that ten different ACs for emergency calls (as is employed in the older class definition) are excessive, especially for emergency calls, because all ordinary users should be allowed to emergency calls if the cell is operating. The permission class definition is defined such that the WTRUs from the home PLMN have a higher priority than the visiting PLMN users, with an access permission class-3 for high-end HPLMN users, a class-2 for low-end HPLMN and high-end VPLMN users, and a class-1 for low-end VPLMN users. Thus, only eight different permission classes are in the AC IE, including five for maintenance groups, which is a reduction of eight bits from current UMTS AC IE.

Referring to Table 7, if a strict priority order is implemented, when a particular AC is barred it may automatically indicate to WTRUs of all lower AC WTRUs that they too are barred from emergency calls. For example, if all WTRUS in AC 6 are barred, then the WTRUs in AC's 0-5 would automatically be aware that they too are barred. Thus, using strict priority, only three bits are needed to indicate the highest barred WTRU class a reduction of thirteen bits from current UMTS AC IE.

In the Permission Class Definition-3, with respect to emergency calls, all ordinary WTRU classes have the same priority, the security service class (AC 12) and the emergency service class (AC 14) are of equivalent permission priority, and the PLMN use class (AC 11) and the PLMN staff (AC 15) are of the same permission priority. The public utility class (AC 13) has its own priority. Accordingly, there are only four distinct permission classes, which provide either a four-bit class-bit-map or a two-bit permission-class hierarchy.

More compact forms of the WTRU AC Permission Mark are shown in Tables 7 and 8. In Table 8, where Permission-1-Barred means all ordinary user WTRUs are barred from making emergency calls, etc.

Referring to Table 7 below, the MD setting indicates that no ACs are barred, therefore all WTRUs may make emergency calls, etc. An AC Permission Mark IE indicating Permission-1-Barred means that all WTRUs in ACs 0-2 are barred. An AC Permission Mark IE indicating Permission-2-Barred means that all WTRUs with ACs 0-6 are barred. An AC Permission Mark IE indicating Permission-3-barred means that all WTRUs with AC 0-9 are barred. An AC Permission Mark IE indicating Permission-4-Barred means that only maintenance class WTRUs with ACs 11, 12, 14, are allowed to make emergency calls. An IE indicating Permission-5-Barred means that only maintenance WTRUs with ACs 11, 14, or 15 are allowed to make emergency calls. An AC Permission Mark IE indicating Permission-6-Barred means that only maintenance class WTRUs with ACs 11 or 15 are allowed to make emergency calls. An AC Permission Mark IE indicating Permission-6-Barred means that only WTRUs in maintenance class (i.e., AC 15) are allowed to make emergency calls. An AC Permission Mark IE indicating All-Barred means that none of the WTRUs are allowed to make emergency calls.

TABLE 7
AC Permission Mark for Emergency Calls (Permission Definition-2)

| IE/Group name | Need | Type and Reference |
|---|---|---|
| AC Permission | MD | Enumerated (Permission-1-Barred, |
| Mark | | Permission-2-Barred, |
| | | Permission-3-Barred, |
| | | Permission-4-Barred, |
| | | Permission-5-Barred, |
| | | Permission-6-Barred, |
| | | Permission-7-Barred, |
| | | All-Barred) |

Referring to Table 8 below, no AC is barred according to the MD for the AC Permission Mark IE. If the AC Permission Mark IE indicates Permission-1-Barred, then all ordinary user WTRUs are barred. If the AC Permission Mark IE indicates Permission-2-Barred then all ordinary user WTRUs and the public service WTRUs are barred. If the AC Permission Mark IE indicates Permission-3-Barred then ACs 0-9, 12, 13, 14 are barred. And finally, if the AC Permission Mark IE indicates All-Barred then none of the WTRUs in any AC are allowed to make emergency calls.

TABLE 8
AC Permission Mark for Emergency Calls (Permission Definition-3)

| IE/Group name | Need | Type and reference |
|---|---|---|
| AC Permission | MD | Enumerated (Permission-1-Barred, |
| Mark | | Permission-2-Barred, |
| | | Permission-3-Barred, |
| | | All-Barred) |

A hierarchical signaling method for AC Emergency Barring assumes a strict priority order hierarchy which means that if WTRU with a higher AC is barred from making emergency calls automatically then all lower AC WTRUs are also barred from making emergency calls. This method fits the nature of the hierarchical nature of the cell access privilege currently already being prevailing in UMTS but greatly reduces the system information signaling space and facilitates more efficient WTRU processing.

Table 9 shows a cell access restriction IE for transmission in an LTE first-to-read SIB. The Cell Barred Status IE is initially set to a MD indicating that the cell is operating and WTRU of all ACs may access the cell. If the Cell Barred Status IE indicates Barred-to-All then all WTRU are barred from access. If the Cell Barred Status IE indicates Barred-for-PLMN maintenance then only ACs 11 and 15 can access. If the Cell Barred Status IE indicates Barred-Reselection-Possible then WTRUs in all ACs are barred, but reselection is possible in either emergency circumstances or after a predetermined time interval. A WTRU that receives a Barred-Reselection-Possible IE uses the reselection indicator and the T_{barred} to determine when/if reselection is possible.

Referring back to Table 9, for the AC Emergency Call Barring IE no ACs are barred in the mandatory default setting. If the AC Emergency Call Barring IE indicates Permission-1-Barred then WTRUs in ordinary user ACs are barred. If the AC Emergency Call Barring IE indicates Permission-2-Barred then WTRUs in the ordinary user ACs and the public service class are barred. If the AC Emergency Call Barring IE indicates Permission-3-Barred then WTRUs in ACs 0-9, 12, 14, 13 are barred. If the AC Emergency Call Barring IE indicates All-Barred then none of the WTRUs in any AC are allowed to make emergency calls.

TABLE 9
Cell Access Restriction IE in LTE first-to-read SIB

| IE/Group name | Need | Type and Reference |
|---|---|---|
| Cell Barred Status | MD | Enumerated (Barred-to-All, |
| | | Barred-for-PLMN-Maintenance, |
| | | Barred-Reselection-Possible, Reserved) |
| Intra-frequency | Optional | Enumerated (not allowed, allowed) |
| Cell Reselection | | |
| Indicator | | |
| T_{barred} | CV-Barred- | Integer (10, 20, 40, 80, 160, 320, |
| | Reselection- | 640, 1280) |
| | Possible | |
| AC Emergency | MD | Enumerated (Permission-1-Barred, |
| Call Barring | | Permission-2-Barred, |
| | | Permission-3-Barred, |
| | | All-Barred) |

In addition to the cell access restriction IE, the Evolved Universal Terrestrial Radio Access (E-UTRA) cell's load factor may also be included in the LTE first-to-read MIB, provided the cell is not barred from access. Thus, when WTRUs attempting reselection to survey a neighbor cell's suitability of reselection such as its PLMN-ID or its signal strength, the WTRU may also check the traffic/service load of that cell in order not to go to a busy cell just to end up with reselecting another one (thus wasting WTRU and BS resources). The best way for a cell to publish its load-factor for the benefit of the network system is in the cell's system information MIB/SIB/SU. A load-factor in integer scale of 1 to n (where n may be 8 or 16 or other integer number for scale), with n being the heaviest is hereby proposed. The load factor at the high level could the combination values from the various operational indicators such as the cell-to-cell, cell-to-network connection X2/S1 interface load, the total cell uplink/downlink signal to noise ratio, the total frequency and code resource usage, the total service, channel capacity and total throughput bandwidth usage and various error rates, etc.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for cell access restriction of a wireless transmit/receive unit (WTRU), the method comprising:
transmitting a cell access restriction information element (IE) in a fast-read master information block (MIB).

2. The method of claim 1, wherein the cell access restriction IE comprises at least one cell restriction status variable selected from Barred to All, Barred for PLMN Maintenance, and Barred Reselection Possible; and
restricting cell access based on a value of the at least one cell restriction status variable.

3. The method of claim 2, wherein the value of the at least one cell restriction status variable includes at least one of the following indications:
the cell is accessible;
the cell is barred to the WTRU;
the cell access is restricted to allow access only to a WTRU used for maintenance; and
the cell is barred for a limited amount of time.

4. The method of claim 3, wherein if the cell is barred to the WTRU for a limited amount of time, the at least one cell restriction status variable value includes a time interval indicating a period of time for which the cell is barred.

5. The method of claim 2, further comprising:
transmitting an indication that a WTRU is allowed to select a new cell.

6. The method of claim 1, wherein the MIB further comprises a load factor for the cell.

7. A method for cell access restriction, the method comprising:
receiving at least one access class (AC) definition including a WTRU barred-bit assignment;
receiving a broadcast including at least one cell access restriction information element (IE); and
determining whether a cell is restricted based on a comparison of the at least one cell access restriction IE to the WTRU barred-bit assignment.

8. The method of claim 7, wherein the cell access restriction IE is contained in a system information block (SIB).

9. The method of claim 7, wherein the cell access restriction IE is contained in a master information block (MIB).

10. The method of claim 7, wherein the cell access restriction IE is contained in a long term evolution signaling unit (SU).

11. A method for cell access restriction of a wireless transmit/receive unit (WTRU) for emergency call handling, the method comprising:
determining a priority order based on an assigned access class (AC) definition, where the assigned AC definition includes at least one of the following:
ordinary user;
public utilities;
security services;
emergency services;
Public Land Mobile Network (PLMN) use; and
PLMN staff;
transmitting a barred bit based on the assigned AC definition; and
transmitting a cell access restriction information element (IE) having a cell access restriction status and a cell access emergency call barred status.

12. The method of claim 11, wherein the security services and the emergency services ACs have the same priority order.

13. The method of claim 11, wherein PLMN use and PLMN staff have the same priority order.

14. The method of claim 13, wherein the ordinary user's AC definition includes at least one of the following:
home PLMN (HPLMN) users; and
visiting PLMN (VPLMN) users;
wherein the HPLMN users have higher priority than VPLMN users.

15. The method of claim 11, wherein the cell access restriction IE is transmitted in a first system information block (SIB), whereby a WTRU reads the first SIB for cell selection and PLMN selection.

16. The method of claim 11, further comprising:
barring cell access on an AC having a higher priority order AC in order to indicate that all the lower priority order ACs are barred from emergency calls.

17. The method of claim 16, further comprising:
including a cell load factor in the long term evolution (LTE) first-to-read SIB if the cell is not barred for access.

18. A base station (BS), the BS comprising:
a processor configured to determine an access class assignment; and
a transmitter configured to transmit a cell access restriction information element (IE) in a fast-read master information block (MIB).

19. The BS of claim 18, wherein the cell access restriction IE comprises at least one cell restriction status variable selected from Barred to All, Barred for PLMN Maintenance, and Barred Reselection Possible; and
the processor is further configured to restrict cell access based on a value of the at least one cell restriction status variable.

20. The BS of claim 19, wherein the value of the at least one cell restriction status variable includes at least one of the following indications:
the cell is accessible;
the cell is barred to the WTRU;
the cell access is restricted to allow access only to a WTRU used for maintenance; and
the cell is barred for a limited amount of time.

21. The BS of claim 20, wherein if the cell is barred to the WTRU for a limited amount of time, the cell restriction status variable value includes a time interval indicating the period of time for which the cell is barred.

22. The BS of claim 19, wherein the transmitter is further transmit to receive an indication that the WTRU is allowed to select a new cell.

23. The BS of claim 18, wherein the MIB further comprises a load factor for the cell.

24. A wireless transmit/receive unit (WTRU), the WTRU comprising:
a receiver configured to receive at least one access class (AC) definition including a WTRU barred-bit assignment and to receive a broadcast including at least one cell access restriction information element (IE); and
a processor configured to determine whether a cell is restricted based on a comparison of the at least one cell access restriction IE to the WTRU barred-bit assignment.

25. The WTRU of claim 24, wherein the cell access restriction IE is contained in a system information block (SIB).

26. The WTRU of claim 24, wherein the cell access restriction IE is contained in a master information block (MIB).

27. The WTRU of claim 24, wherein the cell access restriction IE is contained in a long term evolution (LTE) signaling unit (SU).

28. A base station (BS), the BS comprising:
a processor configured to determine a priority order based on an assigned access class (AC) definition, where the assigned AC definition includes at least one of the following:
ordinary user;
public utilities;
security services;
emergency services;
Public Land Mobile Network (PLMN) use; and
PLMN staff;
a transmitter configured to transmit a barred bit based on the assigned AC definition and to transmit a cell access restriction information element (IE) having a cell access restriction status and a cell access emergency call barred status.

29. The BS of claim 28, wherein the security services and the emergency services ACs have the same priority order.

30. The BS of claim 28, wherein PLMN use and PLMN staff have the same priority order.

31. The BS of claim 30, wherein the ordinary user's AC definition includes at least one of the following:
home PLMN (HPLMN) users; and
visiting PLMN (VPLMN) users;
wherein the HPLMN users have higher priority than VPLMN users.

32. The BS of claim 28, wherein the transmitter is further configured to transmit the cell access restriction IE in a first system information block (SIB), whereby a WTRU reads the first SIB for cell selection and PLMN selection.

33. The BS of claim 28, further comprising:
a processor configured to bar cell access on an AC having a higher priority order AC in order to indicate that all the lower priority order ACs are barred from emergency calls.

34. The BS of claim 33, wherein the transmitter is further configured to transmit a cell load factor in the long term evolution (LTE) first-to-read SIB only if the cell is not barred for access.
